(19) United States
(12) Patent Application Publication
(10) Pub. No.: US 2016/0373664 A1
(43) Pub. Date: Dec. 22, 2016

(54) Methods And Apparatus of Processing Image And Additional Information From Image Sensor

(71) Applicant: MediaTek Inc., Hsinchu (TW)

(72) Inventor: Ming-Chi Wei, Tainan City (TW)

(21) Appl. No.: 15/256,706

(22) Filed: Sep. 5, 2016

Related U.S. Application Data
(60) Provisional application No. 62/246,770, filed on Oct. 27, 2015.

(51) Int. Cl. H04N 5/351; H04N 9/04; H04N 5/369; H04N 5/33; H04N 5/357

(52) U.S. Cl. CPC H04N 5/351; H04N 5/332; H04N 5/3575; H04N 5/3696; H04N 9/045

(57) ABSTRACT

Examples of processing of image and additional information sensed by image sensors are described. A method may involve receiving, from an array of pixels of an image sensor, data sensed by the array of pixels. The array of pixels may include a plurality of imaging pixels capable of sensing image data. The array of pixels may also include one or more information pixels capable of sensing additional information. The sensed data may include the image data and the additional information. The additional information is retrieved from the sensed data

### CROSS REFERENCE TO RELATED PATENT APPLICATION

The present disclosure claims the priority benefit of U.S. Patent Application No. 62/246,770, filed on 27 Oct. 2015, which is incorporated by reference in its entirety.

### TECHNICAL FIELD

The present disclosure is generally related to image sensing and, more particularly, to processing of images and additional information sensed by image sensors.

### BACKGROUND

Unless otherwise indicated herein, approaches described in this section are not prior art to the claims listed below and are not admitted to be prior art by inclusion in this section.

A color image sensor is a sensor that detects or otherwise senses electromagnetic waves in visible light spectrums as color information, or image data, that represents an image. Image sensors commonly utilize a color filter array (CFA) that passes red, green or blue light to pixels of the image sensor, forming interlaced grids sensitive to red, green and blue light. Typically, chromatic pixels are utilized in image sensors to reproduce a sensed color image and, accordingly, color information of the image is subsampled by the chromatic pixels. The color information undergoes raw processing by a processor such as an image signal processor (ISP) so that the image data can be transformed into an image for display.

Sometimes additional information other than chromatic information is desired during image acquisition process by an image sensor. A conventional approach is to change the layout of the CFA to include one or more pixels that sense the desired additional information. However, it is necessary to modify the subsequent raw processing in order to accommodate the change in the layout of the CFA and the sensed additional information. Undesirably, this may require a change in the design of the ISP and additional cost associated with such change.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

An objective of the present disclosure is to propose solution(s), scheme(s), technique(s), method(s) and apparatus that address the aforementioned issue associated with the conventional approach. According to the present disclosure, pixels that sense additional information may be allocated to replace some of the chromatic pixels with the lowest contribution to luminance while the basic layout of the CFA may remain intact. Additional information of one or more types may be sensed in various implementations in accordance with the present disclosure. Advantageously, the proposed solution does not require any change to the hardware of the ISP, thereby saving the additional cost associated with the conventional approach. Put differently, the proposed solution provides the ability to obtain additional information with an image sensor during image acquisition by the image sensor, but without the additional cost of an extra sensor for the additional information.

In one example implementation, a method may involve receiving, from an array of pixels of an image sensor, data sensed by the array of pixels. The array of pixels may include a plurality of imaging pixels capable of sensing image data. The array of pixels may also include one or more information pixels capable of sensing additional information. The sensed data may include the image data and the additional information. The method may also involve obtaining the additional information from the sensed data. The method may further involve processing the sensed data in a way that is used to process the image data without the additional information in the sensed data.

In another example implementation, a method may involve receiving, from an array of pixels of an image sensor, data sensed by the array of pixels. The array of pixels may include a plurality of imaging pixels capable of sensing image data. The array of pixels may also include one or more information pixels capable of sensing additional information. The sensed data may include the image data and the additional information. The image sensor may also include a Bayer filter mosaic such that each pixel of the array of pixels is aligned with a respective filter of the Bayer filter mosaic to sense light intensity in a red, green or blue wavelength region. The method may also involve obtaining the additional information from the sensed data. The method may further involve processing the sensed data in a way that is used to process the image data without the additional information in the sensed data.

In yet another example implementation, an apparatus may include a processor. The processor may be capable of receiving data sensed by an array of pixels of an image sensor. The sensed data may include image data and additional information. The processor may be capable of obtaining the additional information from the sensed data. The processor may be also capable of processing the sensed data in a way that is used to process the image data without the additional information in the sensed data.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example CFA layout scheme in accordance with an implementation of the present disclosure.

FIG. 3 is a diagram of example portions of CFAs in accordance with an implementation of the present disclosure.

FIG. 4 is a diagram of an example portion of a CFA in accordance with an implementation of the present disclosure.

FIG. 5 is a diagram of an example portion of a CFA in accordance with an implementation of the present disclosure.

FIG. 6 is a block diagram of an example apparatus in accordance with an implementation of the present disclosure.

FIG. 7 is a flowchart of an example process in accordance with an implementation of the present disclosure.

FIG. 8 is a flowchart of an example process in accordance with another implementation of the present disclosure.

### DETAILED DESCRIPTION OF PREFERRED EMBODIMENTS

### Overview

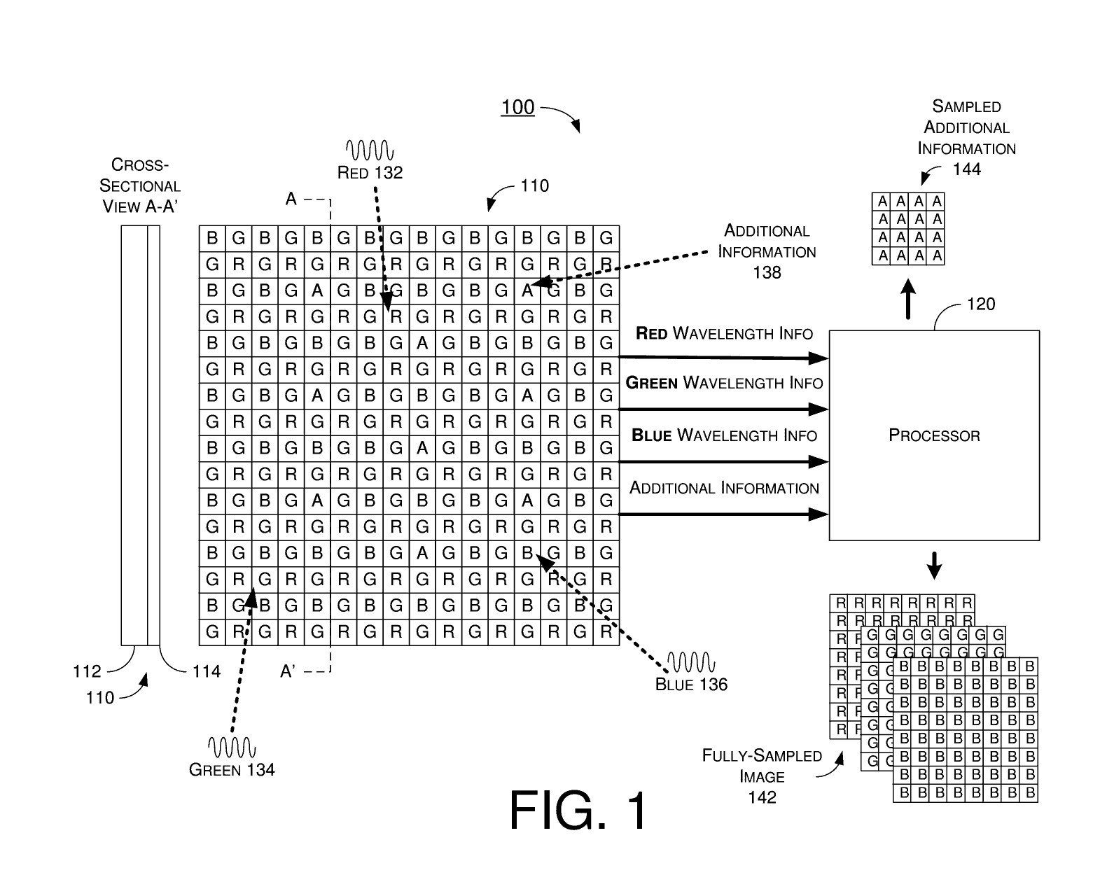

FIG. 1 illustrates an example scenario 100 in accordance with an implementation of the present disclosure. Scenario 100 may involve an image sensor 110 and a processor 120 that are capable of implementing the proposed solution(s), scheme(s), technique(s), method(s) and any variations thereof in accordance with the present disclosure. Image sensor 110 may be capable of sensing data that includes not only image data but also additional information 138 that is not image data. Processor 120 may be communicatively coupled to image sensor 110 to receive and process the data sensed by image sensor 110.

As shown in FIG. 1, image sensor 110 may include an array of pixels 112 and a CFA 114. The array of pixels 112 may include multiple rows and multiple columns of pixels, including numerous imaging pixels and one or more information pixels. In the present disclosure, the term “imaging pixels” refers to pixels that are capable of sensing image data such as chroma, luma and/or hue-related data pertaining to an image. In the present disclosure, the term “information pixels” refers to pixels that are capable of sensing information other than image data such as, for example and not limited to, phase-difference information and infrared (IR) band information.

CFA 114 may include an array of color filters such as red color filters that allow electromagnetic waves 132 in the red light spectrum to pass through, green color filters that allow electromagnetic waves 134 in the green light spectrum to pass through, and blue color filters that allow electromagnetic waves 136 in the blue light spectrum to pass through. These red (R), green (G) and blue (B) color filters may, together, be interchangeably referred to as RGB color filters herein. In some implementations, CFA 114 may have RGB color filters arranged in a pattern as a Bayer filter mosaic. That is, in some implementations, in CFA 114 the proportion of red color filters, green color filters and blue color filters may be 50% green, 25% red and 25% blue. Alternatively, CFA 114 may have RGB color filters in a proportion different than that of a Bayer filter mosaic.

When CFA 114 is disposed on or otherwise aligned with the array of pixels 112, each pixel of the array of pixels 112, whether an imaging pixel or an information pixel, is respectively aligned with a red color filter, green color filter or blue color filter of CFA 114. According to the present disclosure, the location of each information pixel is selected such that each information pixel replaces an imaging pixel with a relatively low contribution to luminance with respect to an image sensed by the array of pixels 112, while maintaining the basic layout of color filters. Among the tricolors of red, green and blue, the color blue tends to contribute to luminance the least compared to the colors red and green. Thus, in some implementations, in terms of location each of the one or more information pixels in the array of pixels 112 may replace a respective imaging pixel aligned with a blue color filter of CFA 114 to sense electromagnetic waves 136 in the blue light spectrum. Moreover, in order to ensure that the basic layout can be recovered, each information pixel is surrounded by imaging pixels that are aligned to sense the color of light which would be sensed by the imaging pixel replaced by the information pixel. In cases that each information pixel replaces an imaging pixel aligned with a blue color filter of CFA 114 to sense electromagnetic waves in the blue light spectrum, each information pixel is surrounded by imaging pixels that are aligned with CFA 114 to sense electromagnetic waves 136 in the blue light spectrum. In the example shown in FIG. 1, a location of a red color filter of CFA 114 is labeled as “R” in image sensor 110, a location of a green color filter of CFA 114 is labeled as “G” in image sensor 110, a location of a blue color filter of CFA 114 is labeled as “B” in image sensor 110, and a location of a filter of CFA 114 aligned with an information pixel is labeled as “A” in image sensor 110.

Processor 120 may receive the sensed data, including image data and additional information 138, from image sensor 110. In accordance with the present disclosure, processor 120 may obtain, determine or otherwise produce a fully-sampled image 142 based on the image data as well as obtain sampled additional information 144. One advantage provided by the present disclosure is that there is no need to alter the image processing performed by processor 120 in order to obtain the fully-sampled image 142 and the sampled additional information 144. In contrast, under conventional approaches, modification to image processing is necessary due to changes in the layout of CFA to accommodate the information pixels.

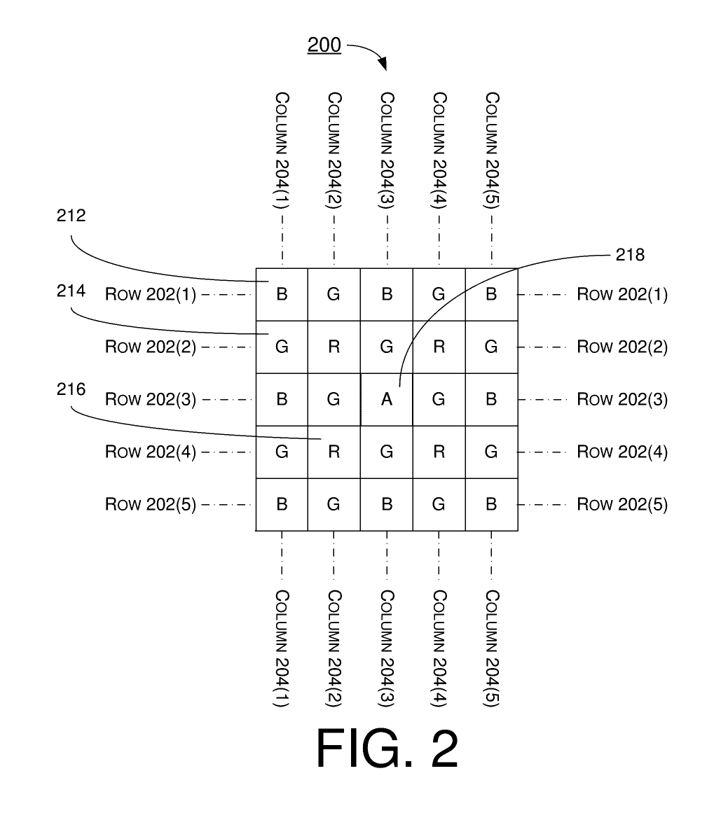

FIG. 2 illustrates an example CFA layout scheme 200 in accordance with an implementation of the present disclosure. Under scheme 200, each information pixel is surrounded by at least one row of pixels in each of two opposing column-wise directions (e.g., at least one row above and at least one row below) and at least one column of pixels in each of two opposing row-wise directions (e.g., at least one column to the left and at least one column to the right) that include imaging pixels aligned to sense at least the electromagnetic waves in the blue light spectrum.

In the example shown in FIG. 2, there are multiple rows of pixels, namely rows 202(1)-202(5), and there are multiple columns of pixels, namely columns 204(1)-204(5). The pixels include imaging pixels 216 aligned to sense electromagnetic waves in the red light spectrum (labeled as “R” in FIG. 2), imaging pixels 214 aligned to sense electromagnetic waves in the green light spectrum (labeled as “R” in FIG. 2), and imaging pixels 212 aligned to sense electromagnetic waves in the blue light spectrum (labeled as “B” in FIG. 2). An information pixel 218, representative of each information pixel under scheme 200, is located at the intersection of row 202(3) and column 204(3). In implementations in which each information pixel replaces an imaging pixel aligned with a blue color filter to sense electromagnetic waves in the blue light spectrum, each information pixel is surrounded by imaging pixels that are aligned with a blue color filter to sense electromagnetic waves in the blue light spectrum. In the example shown in FIG. 2, the location of information pixel 218 is the location that would be occupied by an imaging pixel aligned to sense electromagnetic waves in the blue light spectrum. Accordingly, information pixel 218 is surrounded by imaging pixels 212 aligned to sense electromagnetic waves in the blue light spectrum such as those in rows 202(1), 202(3) and 202(5) as well as those in columns 204(1), 204(3) and 204(5).

Scheme 200 may be utilized regardless of the type of information sensed by the information pixel(s) in an image sensor in accordance with the present disclosure. Although a Bayer filter mosaic is utilized in scheme 200, scheme 200 may also be applicable to a different filter layout.

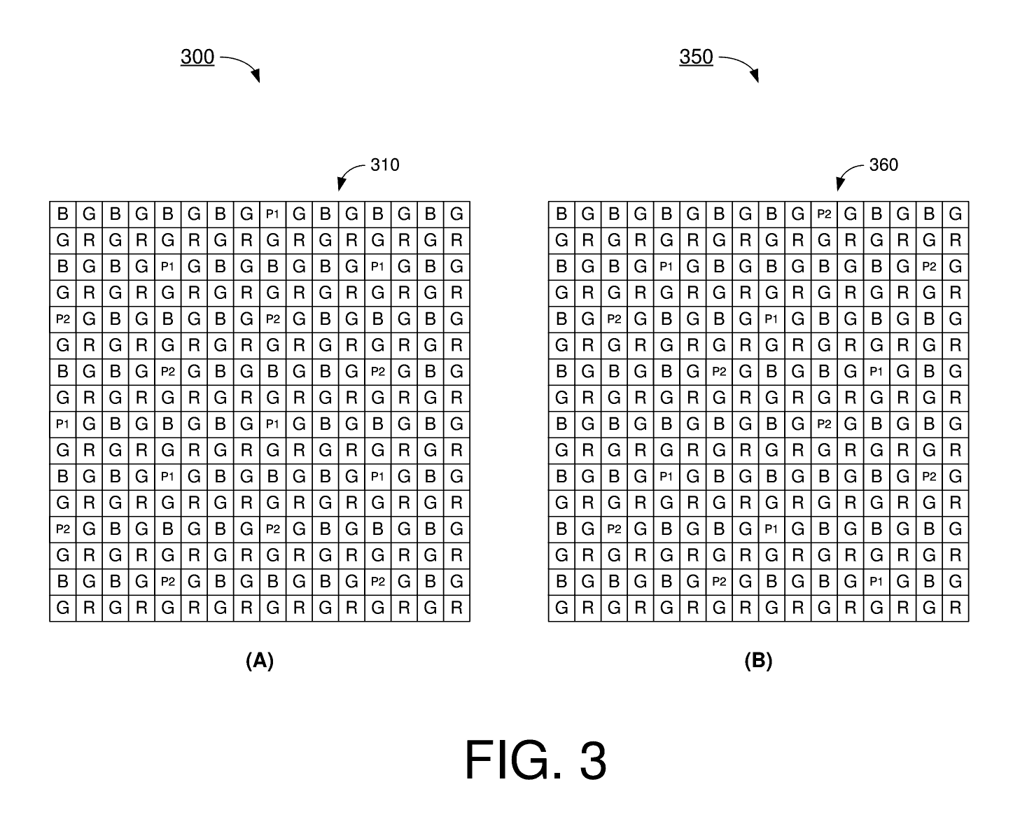

FIG. 3 illustrates an example portion of a CFA 300 and an example portion of a CFA 350 in accordance with an implementation of the present disclosure. As shown in part (A) of FIG. 3, CFA 300 of an image sensor 310 may have RGB color filters arranged in a pattern as a Bayer filter mosaic. Similarly, as shown in part (B) of FIG. 3, CFA 350 of an image sensor 360 may also have RGB color filters arranged in a pattern as a Bayer filter mosaic. That is, in some implementations, in each of CFA 300 and CFA 350 the proportion of red color filters, green color filters and blue color filters may be 50% green, 25% red and 25% blue. Alternatively, CFA 300 and/or CFA 350 may have RGB color filters in a proportion different than that of a Bayer filter mosaic.

Following the principles of scheme 200, in each of image sensor 310 and image sensor 360, each information pixel capable of sensing additional information is situated in or otherwise occupies a location of an imaging pixel that would be aligned with a blue color filter of CFA 300 or CFA 350 to sense electromagnetic waves in the blue light spectrum. In the examples shown in FIG. 3, the additional information to be sensed includes phase-difference information. For instance, phase-difference information of an object to be focused in an image may be helpful to processor 120 in terms of auto-focus performance. Typically a phase difference is calculated from at least two groups of phase detection (PD) pixels referred to as PD pairs, such as first-phase pixels and second-phase pixels. Accordingly, in each of image sensor 310 and image sensor 360, there may be one or more first-phase pixels (labeled as “P1” in FIG. 3) and one or more second-phase pixels (labeled as “P2” in FIG. 3). The one or more first-phase pixels may be capable of sensing a first phase of electromagnetic waves. The one or more second-phase pixels may be capable of sensing a second phase of electromagnetic waves different than the first phase. Moreover, each of the one or more first-phase pixels and the one or more second-phase pixels may occupy a location aligned with a blue color filter of CFA 300 or CFA 350 to sense electromagnetic waves in the blue light spectrum. Based on the proposed allocation, each of the one or more first-phase pixels and one or more second-phase pixels may be surrounded by imaging pixels aligned with CFA 300 or CFA 350 to sense electromagnetic waves in the blue light spectrum.

Moreover, following the principles of scheme 200, each information pixel in image sensor 310 and image sensor 360 is surrounded by imaging pixels that are aligned with CFA 300 and CFA 350, respectively, to sense electromagnetic waves in the blue light spectrum. Put differently, each information pixel in image sensor 310 and image sensor 360 is respectively surrounded by at least one row of pixels in each of two opposing column-wise directions (e.g., one row above and another row below the information pixel in concern) and at least one column of pixels in each of two opposing row-wise directions (e.g., one column to the left and another column to the right of the information pixel in concern) that include imaging pixels aligned to sense at least the electromagnetic waves in the blue light spectrum.

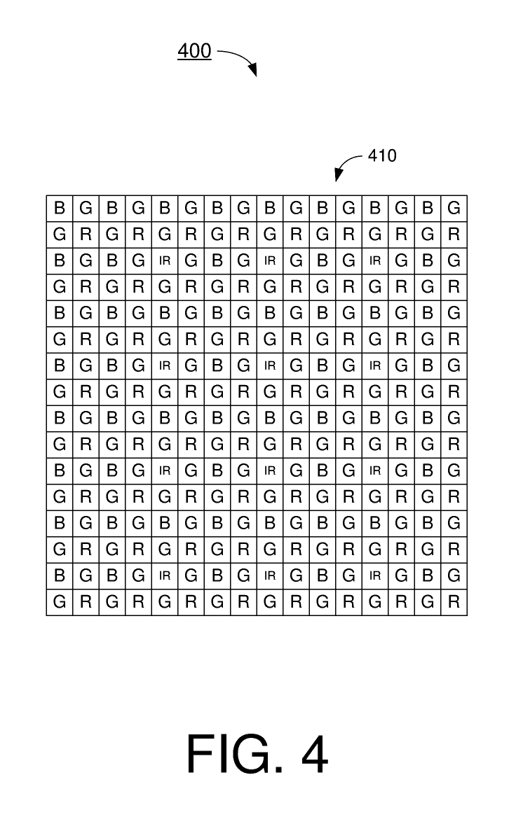

FIG. 4 illustrates an example portion of a CFA 400 in accordance with an implementation of the present disclosure. As shown in FIG. 4, CFA 400 of an image sensor 410 may have RGB color filters arranged in a pattern as a Bayer filter mosaic. That is, in some implementations, in CFA 400 the proportion of red color filters, green color filters and blue color filters may be 50% green, 25% red and 25% blue. Alternatively, CFA 400 may have RGB color filters in a proportion different than that of a Bayer filter mosaic.

Following the principles of scheme 200, in image sensor 410, each information pixel capable of sensing additional information is situated in or otherwise occupies a location of an imaging pixel that would be aligned with a blue color filter of CFA 400 to sense electromagnetic waves in the blue light spectrum. In the example shown in FIG. 4, the additional information to be sensed includes IR band information. For instance, for the purpose of iris recognition, IR band information may be utilized to property reveal the texture structure of the iris of an eye of a user. To implement iris recognition and imaging function on the same image sensor, the pixel dedicated to sensing IR band information may be allocated uniformly as shown in FIG. 4. Accordingly, in image sensor 410, there may be one or more IR pixels (labeled as “IR” in FIG. 4), with the one or more IR pixels capable of sensing IR band information. Moreover, each of the one or more IR pixels may occupy a location aligned with a blue color filter of CFA 400 to sense electromagnetic waves in the blue light spectrum. Based on the proposed allocation, each of the one or more IR pixels may be surrounded by imaging pixels aligned with CFA 400 to sense electromagnetic waves in the blue light spectrum.

Moreover, following the principles of scheme 200, each information pixel in image sensor 410 is surrounded by imaging pixels that are aligned with CFA 400 to sense electromagnetic waves in the blue light spectrum. Put differently, each information pixel in image sensor 410 is respectively surrounded by at least one row of pixels in each of two opposing column-wise directions (e.g., one row above and another row below the information pixel in concern) and at least one column of pixels in each of two opposing row-wise directions (e.g., one column to the left and another column to the right of the information pixel in concern) that include imaging pixels aligned to sense at least the electromagnetic waves in the blue light spectrum.

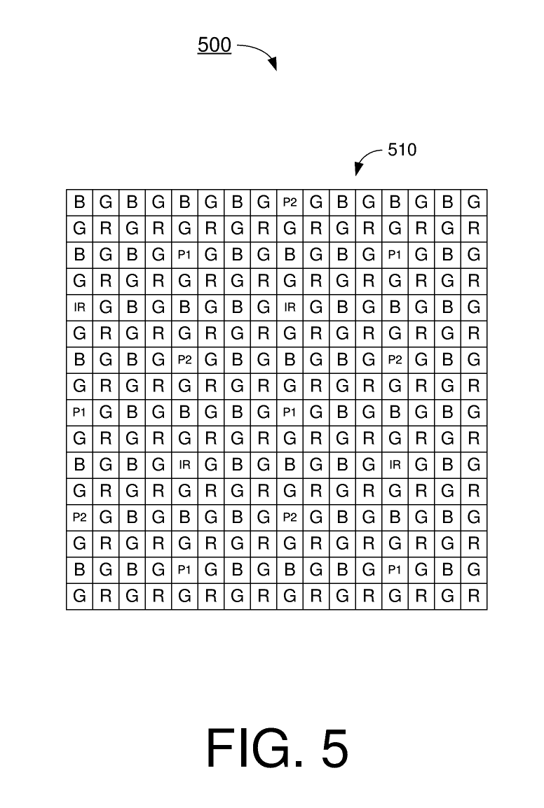

FIG. 5 illustrates an example portion of a CFA 500 in accordance with an implementation of the present disclosure. As shown in FIG. 5, CFA 500 of an image sensor 510 may have RGB color filters arranged in a pattern as a Bayer filter mosaic. That is, in some implementations, in CFA 500 the proportion of red color filters, green color filters and blue color filters may be 50% green, 25% red and 25% blue. Alternatively, CFA 500 may have RGB color filters in a proportion different than that of a Bayer filter mosaic.

Following the principles of scheme 200, in image sensor 510, each information pixel capable of sensing additional information is situated in or otherwise occupies a location of an imaging pixel that would be aligned with a blue color filter of CFA 500 to sense electromagnetic waves in the blue light spectrum. In the example shown in FIG. 5, the additional information to be sensed includes phase-difference information and IR band information. Accordingly, in image sensor 510, there may be one or more first-phase pixels (labeled as “P1” in FIG. 5), one or more second-phase pixels (labeled as “P2” in FIG. 5), and one or more IR pixels (labeled as “IR” in FIG. 5). The one or more first-phase pixels may be capable of sensing a first phase of electromagnetic waves. The one or more second-phase pixels may be capable of sensing a second phase of electromagnetic waves different than the first phase. The one or more IR pixels may be capable of sensing IR band information. Moreover, each of the one or more first-phase pixels, one or more second-phase pixels and one or more IR pixels may occupy a location aligned with a blue color filter of CFA 500 to sense electromagnetic waves in the blue light spectrum. Based on the proposed allocation, each of the one or more first-phase pixels and one or more second-phase pixels may be surrounded by imaging pixels aligned with CFA 300 or CFA 350 to sense electromagnetic waves in the blue light spectrum. Based on the proposed allocation, each of the one or more first-phase pixels, the one or more second-phase pixels and the one or more IR pixels may be surrounded by imaging pixels aligned with CFA 500 to sense electromagnetic waves in the blue light spectrum.

Moreover, following the principles of scheme 200, each information pixel in image sensor 510 is surrounded by imaging pixels that are aligned with CFA 500 to sense electromagnetic waves in the blue light spectrum. Put differently, each information pixel in image sensor 510 is respectively surrounded by at least one row of pixels in each of two opposing column-wise directions (e.g., one row above and another row below the information pixel in concern) and at least one column of pixels in each of two opposing row-wise directions (e.g., one column to the left and another column to the right of the information pixel in concern) that include imaging pixels aligned to sense at least the electromagnetic waves in the blue light spectrum.

Notably, although each of the information pixels in the examples shown in FIG. 3, FIG. 4 and FIG. 5 may occupy a respective location that is aligned with the CFA to sense electromagnetic waves in the blue light spectrum, it is possible that each of the information pixels may occupy a respective location that is aligned with the CFA to sense electromagnetic waves in the spectrum of another visible light having relatively low contribution to luminance regarding a sensed image. For instance, in some implementations, each of the information pixels may occupy a respective location that is aligned with the CFA to sense electromagnetic waves in the red light spectrum.

Additionally, it is noteworthy that although the additional information sensed by the one or more information pixels may be phase-difference information and/or IR band information, the scope of the present disclosure is not limited to sensing phase-difference information, IR band information or a combination thereof. In other words, in some implementations, an image sensor in accordance with the present disclosure may include one or more information pixels capable of sensing information other than phase-difference information and IR band information such as, for example and not limited to, any environmental parameters that can be detected, monitored, measured or otherwise sensed (e.g., atmospheric pressure, humidity and the like).

### Example Implementations

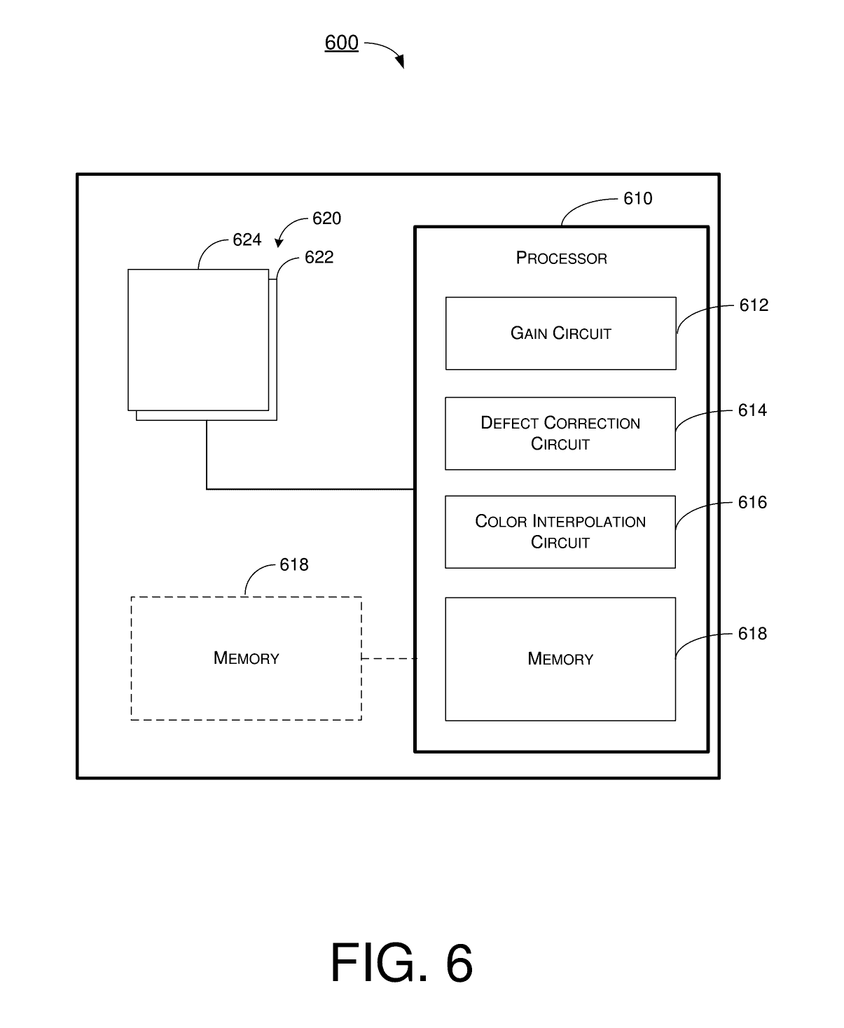

FIG. 6 illustrates an example apparatus 600 in accordance with an implementation of the present disclosure. Apparatus 600 may be capable of implementing scenario 100 described above as well as processes 700 and 800 described below. In some cases, apparatus 600 may be an electronic apparatus such as, for example and not limited to, a smartphone, a digital camera, a tablet computer, a laptop computer, a notebook computer, a portable device or a wearable device. In some cases, apparatus 600 may be implemented in the form of one single integrated-circuit (IC) chip, multiple IC chips or a chipset, and such chip(s) may be employed in any suitable electronic apparatus such as those listed above although not limited thereto. Apparatus 600 may include one or more of those components shown in FIG. 6. Apparatus 600 may also include one or more other components not shown in FIG. 6 which may be irrelevant to the scope of the present disclosure. Therefore, to avoid obscuring the concept intended to be conveyed herein, such components of apparatus 600 are not shown in FIG. 6.

Referring to FIG. 6, apparatus 600 may include a processor 610. Processor 610 may be a microprocessor in the form of one or more IC chips and may be, for example and not limited to, an image signal processor (ISP), an application-specific integrated circuit (ASIC), a system on chip (SOC) or a central processing unit (CPU). Processor 610 may be an example implementation of processor 120. Processor 610 may include hardware capable of performing operations in accordance with the present disclosure, and the hardware of processor 610 may include, for example and not limited to, one or more transistors, one or more diodes, one or more capacitors, one or more resistors, one or more inductors, one or more varactors, one or more thyristors and/or one or more other electronics components. In some implementations, processor 610 may include a gain circuit 612, a defect correction circuit 614 and a color interpolation circuit 616. In some implementations, processor 610 may also include a memory 618 which may be, for example and not limited to, one or more caches, one or more buffers and/or one or more registers. Memory 618 may store firmware, one or more sets of software instructions and/or data therein, and processor 610 may be capable of executing the firmware and/or one or more sets of software instructions in performing various operations in accordance with the present disclosure. Alternatively, memory 618 may be external to and not an integral part of processor 610.

In some implementations, processor 610 may receive, from the array of pixels 622 of image sensor 620, data sensed by the array of pixels 622. The sensed data may include image data and additional information. The image data may include, for example and not limited to, chroma, luma and/or hue-related data pertaining to an image. The additional information may include, for example and not limited to, phase-difference information, IR band information, information on other environmental parameters, or a combination of some or all of the aforementioned types of information. Processor 610 may store the sensed data in memory 618. Processor 610 may also obtain the additional information from the sensed data. Moreover, processor 610 may process the sensed data in a way that is used to process the image data without the additional information in the sensed data. That is, processor 610 may be able to process the sensed data, which includes both image data and additional information, as if there is only image data included in the sensed data while processor 610 is still able to obtain or otherwise extract the additional information from the sensed data. This is one advantage provided by the proposed solution of the present disclosure over conventional approaches.

In some implementations, apparatus 600 may also include an image sensor 620 communicatively coupled to processor 610. Image sensor 620 may include an array of pixels 622 and a CFA 624. Pixels of the array of pixels 622 may be arranged in rows and columns, and may include a plurality of imaging pixels and one or more information pixels. The plurality of imaging pixels may be capable of sensing the image data. The one or more information pixels may be capable of sensing the additional information. CFA 624 may include a plurality of filters, and may be aligned with the array of pixels 622 such that each pixel of the array of pixels 622 is aligned with a respective filter of CFA 624 to sense electromagnetic waves in a red, green or blue light spectrum. In some implementations, CFA 624 may include a Bayer filter mosaic.

In some implementations, when the additional information sensed by the array of pixels 622 includes phase-difference information, the one or more information pixels may include one or more first-phase pixels capable of sensing a first phase of electromagnetic waves and one or more second-phase pixels capable of sensing a second phase of electromagnetic waves different than the first phase. Each of the one or more first-phase pixels and the one or more second-phase pixels may occupy a respective location that is aligned with CFA 624 to sense the electromagnetic waves in the blue light spectrum. Each of the one or more first-phase pixels and the one or more second-phase pixels may be respectively surrounded by at least one row of pixels in each of two opposing column-wise directions and at least one column of pixels in each of two opposing row-wise directions that include imaging pixels aligned to sense at least the electromagnetic waves in the blue light spectrum.

In some implementations, when the additional information sensed by the array of pixels 622 includes IR band information, the one or more information pixels may include one or more IR pixels. Each of the one or more IR pixels may occupy a respective location that is aligned with CFA 624 to sense the electromagnetic waves in the blue light spectrum. Each of the one or more IR pixels may be respectively surrounded by at least one row of pixels in each of two opposing column-wise directions and at least one column of pixels in each of two opposing row-wise directions that include imaging pixels aligned to sense at least the electromagnetic waves in the blue light spectrum.

In some implementations, in obtaining the additional information from the sensed data, processor 610 may be capable of receiving the additional information from the array of pixels 622 without processing the additional information as part of the processing of the sensed data. For example, a communication channel (e.g., electrically conductive wire(s), line(s) or pattern(s)) may be connected between each information pixel and processor 610 so that processor 610 can directly receive the sensed additional information from each information pixel. As another example, processor 610 may, for each pixel of the array of pixels 622 (regardless of whether the pixel is an imaging pixel or an information pixel), compare a value of data sensed by a respective pixel with an average of values of data sensed by neighboring pixels aligned with the CFA 624 to sense electromagnetic waves in the same light spectrum as the light spectrum the respective pixel is also aligned to sense. Based on a result of the comparison, processor 610 may be able to determine whether the value of data sensed by the respective pixel is within a predefined range relative to the average of values of data sensed by its neighboring pixels that are aligned to sense electromagnetic waves of the same light spectrum. When a difference between the value of the data sensed by the respective pixel and the average of values is within the predefined range, processor 610 may consider and treat the data sensed by the respective pixel as chromatic information albeit distorted by noise. On the other hand, when the difference between the value of the data sensed by the respective pixel and the average of values is outside the predefined range, processor 610 may consider and treat the data sensed by the respective pixel as the additional information (e.g., phase difference and/or IR band information). Accordingly, processor 610 may extract the value of the data sensed by the respective pixel as a part of the additional information in response to a determination that the value of the data sensed by the respective pixel is outside the predefined range.

In some implementations, in processing the sensed data in a way that is used to process the image data without the additional information in the sensed data, processor 610 may be capable of performing a number of operations. For instance, gain circuit 612 of processor 610 may perform a gain multiplication operation on the sensed data. Detect correction circuit 614 of processor 610 may determine whether there is abnormality in the sensed data by comparing, for each pixel of the array of pixels 622, data sensed by a respective pixel of the array of pixels 622 with data sensed by one or more other pixels neighboring the respective pixel. Detect correction circuit 614 may also correct the abnormality in response to a determination that there is abnormality in data sensed by one or more pixels of the array of pixels 622. Color interpolation circuit 616 of processor 610 may interpolate the sensed data using an interpolation method used for the image data from imaging pixels of the array of pixels 622. That is, color interpolation circuit 616 may interpolate the sensed data as if there is only image data included in the sensed data without the additional information by using an interpolation method that is used on image data as with conventional image sensors, even though the sensed data also includes the additional information.

In some implementations, in obtaining the additional information from the sensed data, processor 610 may be capable of extracting the additional information from the sensed data prior to or at the defect correction stage.

In some implementations, each pixel of the array of pixels 622 may be aligned with a respective filter of CFA 624 of image sensor 620 to sense electromagnetic waves in a red, green or blue light spectrum. In such cases, in obtaining the additional information from the sensed data, processor 610 may be capable of performing, in response to the determination that there is abnormality in data sensed by the one or more pixels of the array of pixels, a number of operations for each of the one or more pixels. For instance, processor 610 may determine whether a value of data sensed by the respective pixel is within a predefined range relative to an average of values of data sensed by neighboring pixels aligned with CFA 624 to sense electromagnetic waves in a respective light spectrum which the respective pixel is also aligned to sense. Processor 610 may also extract the value of the data sensed by the respective pixel as a part of the additional information in response to a determination that the value of the data sensed by the respective pixel is outside the predefined range.

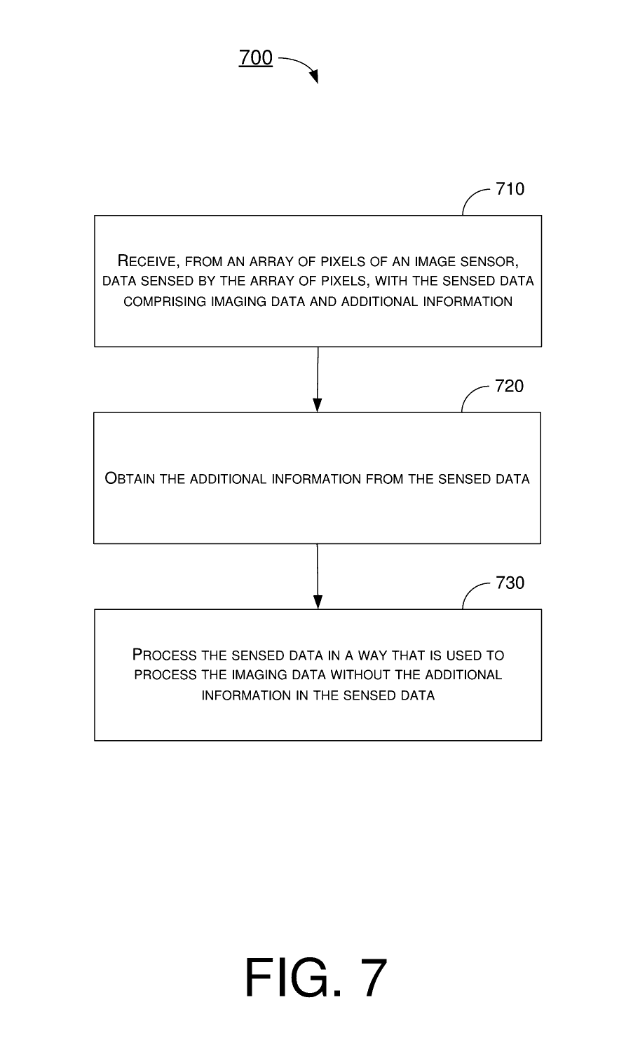

FIG. 7 illustrates an example process 700 in accordance with an implementation of the present disclosure. Process 700 may include one or more operations, actions, or functions as represented by one or more of blocks 710, 720 and 730. Although illustrated as discrete blocks, various blocks of process 700 may be divided into additional blocks, combined into fewer blocks, or eliminated, depending on the desired implementation. The blocks of process 700 may be performed in the order shown in FIG. 7 or in any other order, depending on the desired implementation. Process 700 may be implemented by processor 120 and processor 610 of apparatus 600. Process 700 may be implemented to achieve or otherwise render scenario 100 and scheme 200, any process 700 may be implemented to accommodate example CFA layouts 300, 350, 400 and 600 as well as any variations thereof. Solely for illustrative purpose and without limiting the scope of the present disclosure, process 700 is described below in the context of apparatus 600. Process 700 may begin at 710.

At 710, process 700 may involve processor 610 of apparatus 600 receiving, from the array of pixels 622 of image sensor 620, data sensed by the array of pixels 622. The array of pixels 622 may include a plurality of imaging pixels capable of sensing imaging data. The array of pixels 622 may also include one or more information pixels capable of sensing additional information. The sensed data may include the imaging data and the additional information. Process 700 may proceed from 710 to 720.

At 720, process 700 may involve processor 610 of apparatus 600 obtaining the additional information from the sensed data. Process 700 may proceed from 720 to 730.

At 730, process 700 may involve processor 610 of apparatus 600 processing the sensed data in a way that is used to process the imaging data without the additional information in the sensed data.

In some implementations, the additional information may include phase-difference information. The one or more information pixels may include one or more first-phase pixels, capable of sensing a first phase of electromagnetic waves, as well as one or more second-phase pixels, capable of sensing a second phase of electromagnetic waves different than the first phase. In some implementations, the array of pixels 622 may be arranged in rows and columns. The image sensor 620 may also include a CFA 624 such that each pixel of the array of pixels 622 may be aligned with a respective filter of the CFA 624 to sense electromagnetic waves in a red, green or blue light spectrum. Each of the one or more first-phase pixels and the one or more second-phase pixels may occupy a respective location that is aligned with the CFA 624 to sense the electromagnetic waves in the blue light spectrum and may be respectively surrounded by at least one row of pixels in each of two opposing column-wise directions and at least one column of pixels in each of two opposing row-wise directions that include imaging pixels aligned to sense at least the electromagnetic waves in the blue light spectrum.

In some implementations, the additional information may include IR band information. The one or more information pixels may include one or more IR pixels. In some implementations, the array of pixels 622 may be arranged in rows and columns. The image sensor 620 may also include CFA 624 such that each pixel of the array of pixels 622 may be aligned with a respective filter of the CFA 624 to sense electromagnetic waves in a red, green or blue light spectrum. Each of the one or more IR pixels may occupy a respective location that is aligned with the CFA 624 to sense the electromagnetic waves in the blue light spectrum and may be respectively surrounded by at least one row of pixels in each of two opposing column-wise directions and at least one column of pixels in each of two opposing row-wise directions that include imaging pixels aligned to sense at least the electromagnetic waves in the blue light spectrum.

In some implementations, in obtaining the additional information from the sensed data, process 700 may involve processor 610 of apparatus 600 receiving the additional information from the one or more information pixels without processing the additional information as part of the processing of the sensed data.

In some implementations, in processing the sensed data in a way that is used to process the imaging data without the additional information in the sensed data, process 700 may involve processor 610 of apparatus 600 performing a number of operations. For instance, process 700 may involve processor 610 performing, at a gain stage by gain circuit 612, a gain multiplication operation on the sensed data. Process 700 may also involve processor 610 determining, at a defect correction stage by defect correction circuit 614, whether there is abnormality in the sensed data by comparing, for each pixel of the array of pixels 622, data sensed by a respective pixel of the array of pixels 622 with data sensed by one or more other pixels neighboring the respective pixel. Process 700 may further involve processor 610 correcting, at the defect correction stage by defect correction circuit 614, the abnormality in response to a determination that there is abnormality in data sensed by one or more pixels of the array of pixels 622. Process 700 may additionally involve processor 610 interpolating, at a color interpolation stage by color interpolation circuit 616, the sensed data using an interpolation method used for the image data from imaging pixels of the array of pixels 622.

In some implementations, in obtaining the additional information from the sensed data, process 700 may involve processor 610 of apparatus 600 extracting the additional information from the sensed data prior to or at the defect correction stage.

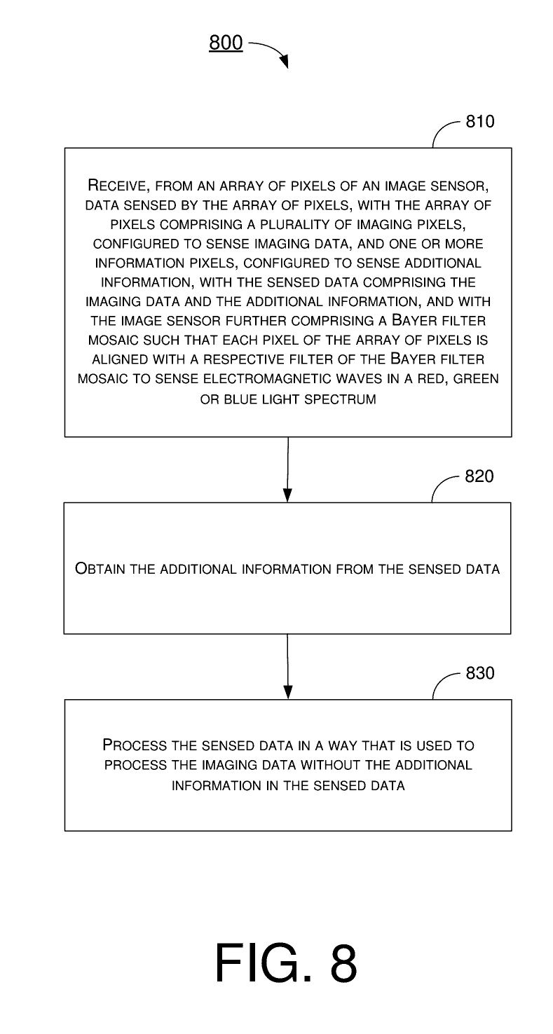

FIG. 8 illustrates an example process 800 in accordance with an implementation of the present disclosure. Process 800 may include one or more operations, actions, or functions as represented by one or more of blocks 810, 820 and 830. Although illustrated as discrete blocks, various blocks of process 800 may be divided into additional blocks, combined into fewer blocks, or eliminated, depending on the desired implementation. The blocks of process 800 may be performed in the order shown in FIG. 8 or in any other order, depending on the desired implementation. Process 800 may be implemented by processor 120 and processor 610 of apparatus 600. Process 800 may be implemented to achieve or otherwise render scenario 100 and scheme 200, any process 800 may be implemented to accommodate example CFA layouts 300, 350, 400 and 600 as well as any variations thereof. Solely for illustrative purpose and without limiting the scope of the present disclosure, process 800 is described below in the context of apparatus 600. Process 800 may begin at 810.

At 810, process 800 may involve processor 610 of apparatus 600 receiving, from the array of pixels 622 of an image sensor 620, data sensed by the array of pixels 622. The array of pixels 622 may include a plurality of imaging pixels capable of sensing imaging data. The array of pixels 622 may also include one or more information pixels capable of sensing additional information. The sensed data may include the imaging data and the additional information. The image sensor 620 may also include CFA 624 which may be a Bayer filter mosaic such that each pixel of the array of pixels 622 may be aligned with a respective filter of the Bayer filter mosaic to sense electromagnetic waves in a red, green or blue light spectrum. Process 800 may proceed from 810 to 820.

At 820, process 800 may involve processor 610 of apparatus 600 obtaining the additional information from the sensed data. Process 800 may proceed from 820 to 830.

At 830, process 800 may involve processor 610 of apparatus 600 processing the sensed data in a way that is used to process the imaging data without the additional information in the sensed data.

In some implementations, the additional information may include phase-difference information, IR band information, or a combination thereof.

In some implementations, in obtaining the additional information from the sensed data, process 800 may involve processor 610 of apparatus 600 receiving the additional information from the array of pixels without processing the additional information as part of the processing of the sensed data.

In some implementations, in processing the sensed data in a way that is used to process the imaging data without the additional information in the sensed data, process 800 may involve processor 610 of apparatus 600 performing a number of operations. For instance, process 800 may involve processor 610 of apparatus 600 performing, at a gain stage by gain circuit 612, a gain multiplication operation on the sensed data. Process 800 may also involve processor 610 of apparatus 600 determining, at a defect correction stage by defect correction circuit 614, whether there is abnormality in the sensed data by comparing, for each pixel of the array of pixels 622, data sensed by a respective pixel of the array of pixels 622 with data sensed by one or more other pixels neighboring the respective pixel. Process 800 may further involve processor 610 of apparatus 600 correcting, at the defect correction stage by defect correction circuit 614, the abnormality in response to a determination that there is abnormality in data sensed by one or more pixels of the array of pixels 622. Process 800 may additionally involve processor 610 of apparatus 600 interpolating, at a color interpolation stage by color interpolation circuit 616, the sensed data using an interpolation method used for the image data from imaging pixels of the array of pixels 622.

In some implementations, in obtaining the additional information from the sensed data, process 800 may involve processor 610 of apparatus 600 extracting the additional information from the sensed data prior to or at the defect correction stage.

Alternatively or additionally, in obtaining the additional information from the sensed data comprises, in response to the determination that there is abnormality in data sensed by the one or more pixels of the array of pixels 622, process 800 may involve processor 610 of apparatus 600 performing operations for each respective pixel of the one or more pixels. For instance, process 800 may involve processor 610 of apparatus 600 determining, whether a value of data sensed by the respective pixel is within a predefined range relative to an average of values of data sensed by neighboring pixels aligned with the CFA 624 to sense electromagnetic waves in a respective light spectrum which the respective pixel is also aligned to sense. In some implementations, when a difference between the value of the data sensed by the respective pixel and the average of values is within the predefined range, it may be assumed that the data sensed by the respective pixel is chromatic information albeit distorted by noise. On the other hand, when the difference between the value of the data sensed by the respective pixel and the average of values is outside the predefined range, it may be assumed that the data sensed by the respective pixel is the additional information (e.g., phase difference and/or IR band information). Process 800 may also involve processor 610 of apparatus 600 extracting the value of the data sensed by the respective pixel as a part of the additional information in response to a determination that the value of the data sensed by the respective pixel is outside the predefined range.

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, from an array of pixels of an image sensor, data sensed by the array of pixels, the sensed data comprising image data and additional information;
obtaining the additional information from the sensed data; and
processing the sensed data in a way that is used to process the image data without the additional information in the sensed data.

2. The method of claim 1, wherein the additional information comprises phase-difference information, wherein the array of pixels comprises a plurality of imaging pixels capable of sensing the image data, wherein the array of pixels further comprises one or more information pixels capable of sensing the additional information, and wherein the one or more information pixels comprise one or more first-phase pixels capable of sensing a first phase of electromagnetic waves and one or more second-phase pixels capable of sensing a second phase of electromagnetic waves different than the first phase.

3. The method of claim 2, wherein the array of pixels are arranged in rows and columns, wherein the image sensor further comprises a color filter array (CFA) such that each pixel of the array of pixels is aligned with a respective filter of the CFA to sense electromagnetic waves in a red, green or blue light spectrum, and wherein each of the one or more first-phase pixels and the one or more second-phase pixels occupies a respective location that is aligned with the CFA to sense the electromagnetic waves in the blue light spectrum and is respectively surrounded by at least one row of pixels in each of two opposing column-wise directions and at least one column of pixels in each of two opposing row-wise directions that include imaging pixels aligned to sense at least the electromagnetic waves in the blue light spectrum.

4. The method of claim 1, wherein the additional information comprises infrared (IR) band information, wherein the array of pixels comprises a plurality of imaging pixels capable of sensing the image data, wherein the array of pixels further comprises one or more information pixels capable of sensing the additional information, and wherein the one or more information pixels comprise one or more IR pixels.

5. The method of claim 4, wherein the array of pixels are arranged in rows and columns, wherein the image sensor further comprises a color filter array (CFA) such that each pixel of the array of pixels is aligned with a respective filter of the CFA to sense electromagnetic waves in a red, green or blue light spectrum, and wherein each of the one or more IR pixels occupies a respective location that is aligned with the CFA to sense the electromagnetic waves in the blue light spectrum and is respectively surrounded by at least one row of pixels in each of two opposing column-wise directions and at least one column of pixels in each of two opposing row-wise directions that include imaging pixels aligned to sense at least the electromagnetic waves in the blue light spectrum.

6. The method of claim 1, wherein the array of pixels comprises a plurality of imaging pixels capable of sensing the image data, wherein the array of pixels further comprises one or more information pixels capable of sensing the additional information, and wherein the obtaining of the additional information from the sensed data comprises receiving the additional information from the one or more information pixels without processing the additional information as part of the processing of the sensed data.

7. The method of claim 1, wherein the processing of the sensed data in a way that is used to process the image data without the additional information in the sensed data comprises:
performing, at a gain stage, a gain multiplication operation on the sensed data;
determining, at a defect correction stage, whether there is abnormality in the sensed data by comparing, for each pixel of the array of pixels, data sensed by a respective pixel of the array of pixels with data sensed by one or more other pixels neighboring the respective pixel;
correcting, at the defect correction stage, the abnormality in response to a determination that there is abnormality in data sensed by one or more pixels of the array of pixels; and
interpolating, at a color interpolation stage, the sensed data using an interpolation method used for a plurality of imaging pixels of the image sensor that are capable of sensing the image data.

8. The method of claim 7, wherein the obtaining of the additional information from the sensed data comprises extracting the additional information from the sensed data prior to or at the defect correction stage.

9. A method, comprising:
receiving, from an array of pixels of an image sensor, data sensed by the array of pixels, the array of pixels comprising a plurality of imaging pixels capable of sensing image data, the array of pixels further comprising one or more information pixels capable of sensing additional information, the sensed data comprising the image data and the additional information, the image sensor further comprising a Bayer filter mosaic such that each pixel of the array of pixels is aligned with a respective filter of the Bayer filter mosaic to sense electromagnetic waves in a red, green or blue light spectrum;
obtaining the additional information from the sensed data; and
processing the sensed data in a way that is used to process the image data without the additional information in the sensed data.

10. The method of claim 9, wherein the additional information comprises phase-difference information, infrared (IR) band information, or a combination thereof.

11. The method of claim 9, wherein the obtaining of the additional information from the sensed data comprises receiving the additional information from the array of pixels without processing the additional information as part of the processing of the sensed data.

12. An apparatus, comprising:
a processor capable of performing operations comprising:
receiving, from an array of pixels of an image sensor, data sensed by the array of pixels, the sensed data comprising image data and additional information;
obtaining the additional information from the sensed data; and
processing the sensed data in a way that is used to process the image data without the additional information in the sensed data.

13. The apparatus of claim 12, wherein the additional information comprises phase-difference information, infrared (IR) band information, or a combination thereof.

14. The apparatus of claim 12, wherein, in obtaining the additional information from the sensed data, the processor is capable of receiving the additional information from the array of pixels without processing the additional information as part of the processing of the sensed data.

15. The apparatus of claim 12, wherein, in processing the sensed data in a way that is used to process the image data without the additional information in the sensed data, the processor is capable of performing operations comprising:
performing, by a gain circuit of the processor, a gain multiplication operation on the sensed data;
determining, by a defect correction circuit of the processor, whether there is abnormality in the sensed data by comparing, for each pixel of the array of pixels, data sensed by a respective pixel of the array of pixels with data sensed by one or more other pixels neighboring the respective pixel;
correcting, by the defect correction circuit, the abnormality in response to a determination that there is abnormality in data sensed by one or more pixels of the array of pixels; and
interpolating, by a color interpolation circuit of the processor, the sensed data for the plurality of imaging pixels.

16. The apparatus of claim 15, wherein, in obtaining the additional information from the sensed data, the processor is capable of extracting the additional information from the sensed data prior to or at the defect correction stage.

17. The apparatus of claim 15, wherein each pixel of the array of pixels is aligned with a respective filter of a color filter array (CFA) of the image sensor to sense electromagnetic waves in a red, green or blue light spectrum, and wherein, in obtaining the additional information from the sensed data, the processor is capable of performing, in response to the determination that there is abnormality in data sensed by the one or more pixels of the array of pixels, operations for each of the one or more pixels, the operations comprising:
determining whether a value of data sensed by the respective pixel is within a predefined range relative to an average of values of data sensed by neighboring pixels aligned with the CFA to sense electromagnetic waves in a respective light spectrum which the respective pixel is also aligned to sense; and
extracting the value of the data sensed by the respective pixel as a part of the additional information in response to a determination that the value of the data sensed by the respective pixel is outside the predefined range.

18. The apparatus of claim 12, further comprising:
the image sensor communicatively coupled to the processor, the image sensor comprising:
the array of pixels comprising a plurality of imaging pixels and one or more information pixels, the plurality of imaging pixels capable of sensing the image data, the one or more information pixels capable of sensing the additional information; and
a color filter array (CFA) comprising a Bayer filter mosaic, the CFA aligned with the array of pixels such that each pixel of the array of pixels is aligned with a respective filter of the CFA to sense electromagnetic waves in a red, green or blue light spectrum.

19. The apparatus of claim 18, wherein the array of pixels are arranged in rows and columns, wherein the additional information comprises phase-difference information, wherein the one or more information pixels comprise one or more first-phase pixels capable of sensing a first phase of electromagnetic waves and one or more second-phase pixels capable of sensing a second phase of electromagnetic waves different than the first phase, and wherein each of the one or more first-phase pixels and the one or more second-phase pixels occupies a respective location that is aligned with the CFA to sense the electromagnetic waves in the blue light spectrum and is respectively surrounded by at least one row of pixels in each of two opposing column-wise directions and at least one column of pixels in each of two opposing row-wise directions that include imaging pixels aligned to sense at least the electromagnetic waves in the blue light spectrum.

20. The apparatus of claim 18, wherein the array of pixels are arranged in rows and columns, wherein the additional information comprises infrared (IR) band information, wherein the one or more information pixels comprise one or more IR pixels, and wherein each of the one or more IR pixels occupies a respective location that is aligned with the CFA to sense the electromagnetic waves in the blue light spectrum and is respectively surrounded by at least one row of pixels in each of two opposing column-wise directions and at least one column of pixels in each of two opposing row-wise directions that include imaging pixels aligned to sense at least the electromagnetic waves in the blue light spectrum.
